(19) United States
(12) Patent Application Publication
(10) Pub. No.: US 2009/0133316 A1
(43) Pub. Date: May 28, 2009

(54) Carrying Case

(76) Inventor: Brent A. Richter, Simi Valley, CA (US)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 11/946,019

(22) Filed: Nov. 27, 2007

(51) Int. Cl. A45C 3/02; A01K 97/06; A45C 13/00

(52) U.S. Cl. 43/54.1; 190/100; 190/103; 190/115

(57) ABSTRACT

A case adaptable for multiple applications and, in particular, for supporting a laptop computer in a horizontal, open and unobstructed work mode and for securing the computer in a closed, upright carrying and storage mode. The case comprises a bottom wall for supporting the case in the work mode, a front wall, a rear wall for supporting the case in the carrying and storage mode, opposite side walls, an open upper end, an interior support tray spaced above the bottom wall so as to define a thermal insulating cavity therebetween and a door slidable between a closed position and an open position. In the closed position, the door extends across the upper end of the case. In the open position the door is substantially disposed in the cavity between the bottom wall and the support tray, providing unobstructed access to the computer in the work mode.

### BACKGROUND OF THE INVENTION

The present invention relates to a protective carrying case particularly adapted for portable personal computers, also known as laptop computers. Existing carrying cases for such devices are typically formed of a lightweight fabric material that provides relatively little protection for their contents. Other carrying cases that do provide protection for their contents are essentially rigid boxes that are cumbersome and heavy to carry and like the fabric cases, must be stored when the computer is in use. With the widespread and growing use of laptop computers by riders on mass transit vehicles, storage of the carrying case can present a problem. Laptop computers generate heat during use which can become uncomfortable to the user's lap under prolonged periods of use such as those encountered on long train or bus commutes where desk or tabletops are not available. These and other shortcomings in the currently available carrying cases for laptop computers are addressed by the present invention.

Another application for which the present invention is particularly suited is the carrying and storage of fishing tackle. Fishing tackle boxes, like laptop computers, can also present a storage problem. Tackle boxes typically have a relatively large foot print and space on a small fishing boat is generally at a premium. Tackle boxes also create an organizational problem in view of the numerous different items that fisherman typically carry, the variations in the size and shape of many of those items and the desirability of segregating the items by genus and size. The result is a relatively large box housing at least one, and more typically, a plurality of vertically stacked compartmentalized trays on which individual items comprising the fishing tackle or collections of such items of the same size and style are contained and segregated. Locating a particular item of a given size on one of a plurality of stacked trays can be time consuming and frustrating. These and other shortcomings in currently available tackle boxes are also addressed by the present invention.

### SUMMARY OF THE INVENTION

Briefly, the carrying case of the present invention is of a lightweight, generally rigid construction and includes a bottom wall, front, rear and side walls, an upper open end, an interior support tray spaced above the bottom wall and a slidably mounted door. In the closed position, the door extends across the upper end of the case, and in the open position, the door is substantially disposed out of view in the area between the bottom wall of the carrying case and the support tray. In laptop computer applications, the slidable door preferably is a tambour-type door and in the closed position, the door cooperates with the support tray to form a clam shell enclosure for the laptop computer, securing the computer in place within the case without the need for straps or other securement devices. In the closed position, the case can be stored in a stable upright disposition so as to occupy a minimal amount of flat space, or the case can rest on its bottom wall in a horizontal disposition. In the open position, the case is in a horizontal disposition and provides unobstructed and convenient access to the computer for use within the carrying case while providing a rigid support for the computer and thermal insulation protecting the user's legs.

In preferred embodiments of the invention, the door is carried by and slidable along opposed elongated c-shaped tracks formed in the side walls of the case so as to avoid obstructing the interior of the case while defining exterior handholds for gripping and manipulating the carrying case in a horizontal working disposition. Openings are provided in the interior of the case proximate the rear wall thereof so as to cooperate with the interior fan of the computer to vent heated air from the carrying case during use while providing a pathway for additional electrical feeds into the case.

In fishing tackle applications, the slidable door is preferably formed of a flexible transparent vinyl material to help render the case water resistant and to allow the user to view the contents therethrough while the door is in the closed position. The support tray for the fishing tackle defines a plurality of open compartments thereon for segregating the various items to be carried and is positioned such that when the sliding door is in the open position all of the compartments and their contents are visible and readily accessible, and in the closed position, the door extends across and closes each of the individual compartments such that the case can be stored on its rear end in an upright disposition with its contents secured in place.

### BRIEF DESCRIPTION OF THE DRAWINGS

FIG. 1 is a perspective view of a first embodiment of the carrying case of the present invention with the slidable door in a closed position.

FIG. 2 is a perspective view of the first embodiment of the carrying case of the present invention with the door in an open position.

FIG. 3 is a perspective view of the first embodiment of the carrying case of the present invention in an upright disposition.

FIG. 4 is a sectional view taken along the line 4-4 in FIG. 2.

FIG. 5 is a sectional view taken along the line 5-5 in FIG. 2.

FIG. 6 is a section view taken along the line 6-6 in FIG. 2.

FIG. 7 is a side view of the first embodiment of the carrying case of the present invention with the slidable door and a guide track for the door being shown in dashed lines.

FIGS. 8A and 8B are partial perspective views of the front end of the first embodiment of the carrying case of the present invention illustrating the movement of the carrying handle.

FIG. 9 is a perspective view of the first embodiment of the carrying case of the present invention with the slidable door in the open position and a laptop computer disposed within the case.

FIG. 10 is a perspective view of the second embodiment of the carrying case of the present invention with the slidable door in a closed position.

FIG. 11 is a perspective view of the second embodiment of the carrying case of the present invention with the slidable door in an open position.

FIG. 12 is a perspective view of another application of the carrying case of the present invention.

FIG. 13 is a partial perspective view illustrating a tambour door configuration for use in the present invention.

### DETAILED DESCRIPTION OF THE PREFERRED EMBODIMENTS

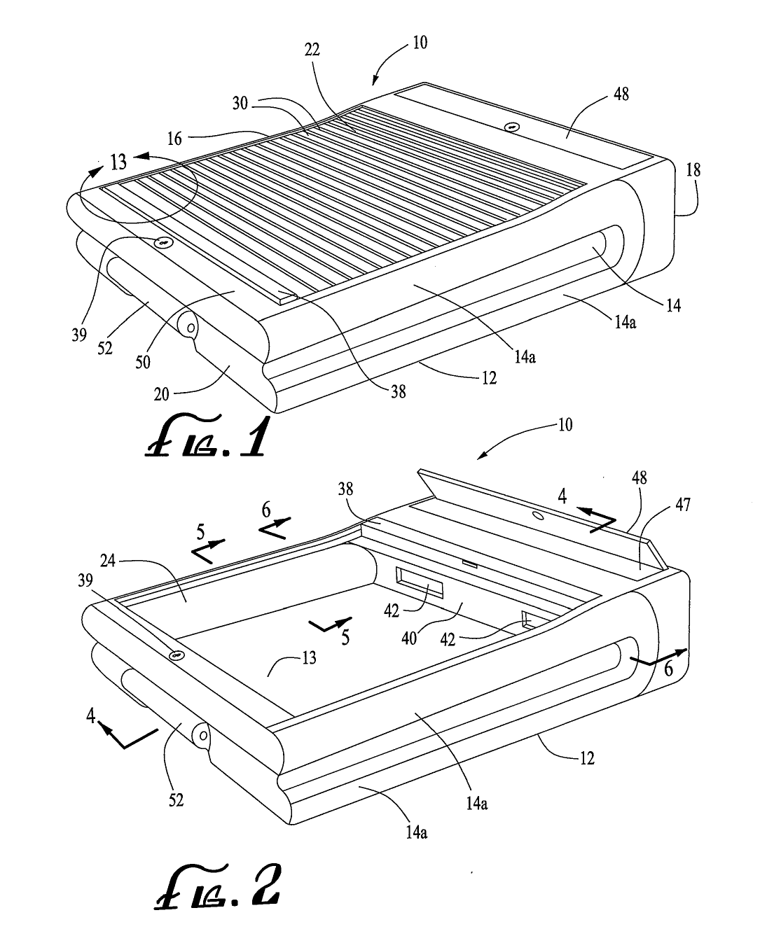

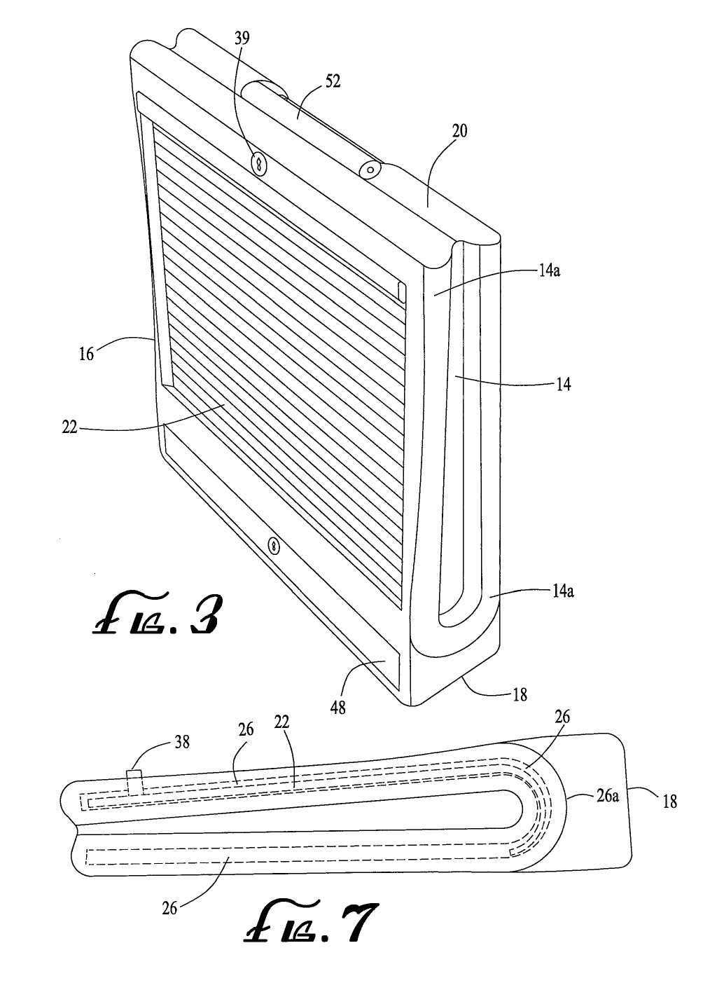

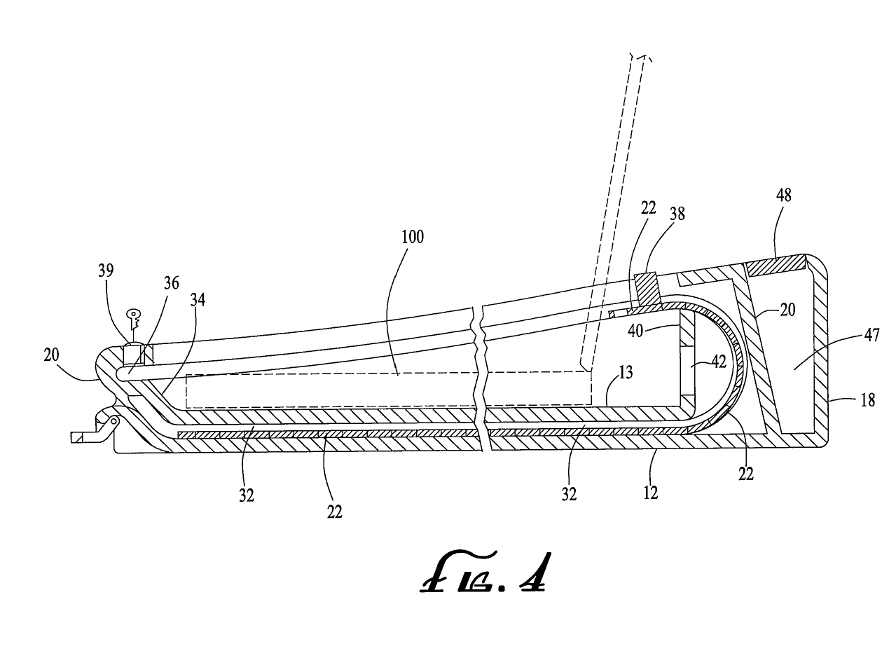

A first embodiment of a carrying case 10 of the present invention is particularly adapted for laptop computers and comprises a bottom wall 12, an interior computer support tray 13 spaced upwardly from wall 12, side walls 14 and 16, a front wall 18, a rear wall 20 and a slidable door 22 that extends across the upper open end 24 of the carrying case 10 in the closed position. In this first embodiment of the present invention, door 22 is preferably a tambour-type roller door. The terminology used to describe the carrying case 10 is with reference to the case in the horizontal working or use position illustrated, for example, in FIGS. 1 and 2, as opposed to the upright carrying and storage position illustrated in FIG. 3. The door 22 is carried by and slides along a pair of opposed, elongated c-shaped guide tracks in the side walls 14 and 16 of the case 10 so as to be readily moveable between the closed position of FIG. 1 and the open position of FIG. 2.

While various materials and methods of construction could be employed to render case 10 durable, rigid and light in weight, in a preferred embodiment, the case is injection molded, using acrylonitrile butadiene styrene (ABS) or other similar material. By so forming the case, the guide tracks 26 and 28 for the tambour-type roller door 22 can be molded into the side walls 14 and 16 of the case 10 so as to avoid any obstruction of the interior of the carrying case while forming handholds 30 on the exterior of the case side walls 14 and 16 for holding and maneuvering the case in the horizontal use position.

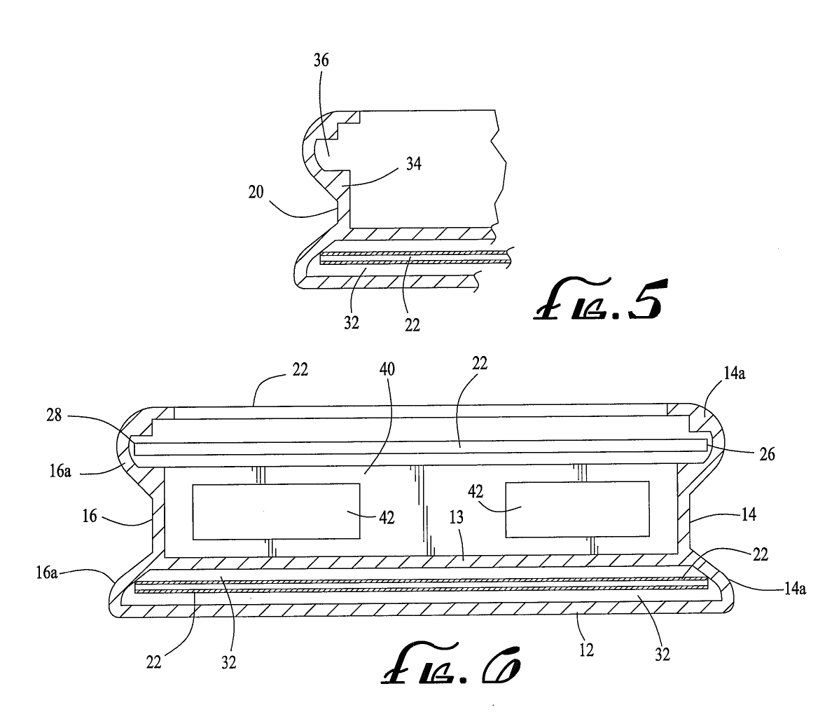

The opposed door guide tracks 26 and 28 are of identical configuration and each define relatively tight turns at the rearward ends thereof (only the rearward end 26a of guide track 26 is visible in the drawings—see FIG. 7). Tambour door 22 can be comprised of a plurality of interlocking slats 30. As seen in FIG. 13, each slat 30 defines an outer surface 30a, an inner surface 30b, a channel 31 extending along one side thereof and a cylindrical bead 33 extending along the other side of the slat parallel to the central axis of channel 31. Bead 33 is joined to the slat by a thin web 35 and is sized to be slidably received in the channel 31 of an adjacent slat. Each channel 31 is provided with a lateral opening 37 so as to accommodate the web 35 of the adjacent slat to define the interlocking door structure and allow sufficient relative rotation of the beads 33 within the channels 31 of adjacent slats to enable the door to negotiate the turns defined by the guide tracks with the end portions of the slats being disposed within and riding along the two tracks. By making such a relatively tight turn, the door 22 can slide from its closed position extending across the upper end 24 of the case into the area 32 between bottom wall 12 and tray 13 where the door is out of sight, does not in any way obstruct access to or use of a laptop computer positioned on support tray 13 and does not require separate storage while the computer is in use. For reasons to be explained, support tray 13 preferably is inclined downwardly from front to rear and merges at its forward end 13a into a rounded interior upstanding wall surface 34.

An elongated opening or slot 36 is provided at the upper end of wall surface 34. Slot 36 cooperates with tracks 26 and 28 to receive the perimeter forward end and side portions of the tambour door 22 when the door is in the closed position. An upwardly projecting flange 38 extends transversely across the door proximate the forward edge thereof to facilitate sliding movement of the door. Flange 38 is rearwardly disposed from the forward edge of the door such that the end portion can extend into the interior slot 36 in the forward end of the case. A suitable locking mechanism 39 is preferably provided in the forward end of the case for cooperating with the forward end portion of the door and/or flange 38 to lock the door in the closed position.

A rear tray wall 40 extends upwardly between side walls 14 and 16 across the rear end of tray 13. Wall 40 is forwardly spaced from the rear wall 20 of the carrying case 10 and cooperates with side walls 14 and 16 and the forward wall surface 34 to contain a laptop computer 100 on tray 13. Spaced openings 42 are preferably provided in the rear tray wall 40 to cooperate with the exhaust fan (not shown) in the laptop computer for venting heated air through openings 42 and area 32, about the portion of door 22 therein and out of the case and away from the user's lap. Openings 42 also provide a pathway for external electrical feeds to the computer. A plurality of openings (not shown), covered by suitable plugs can be provided in a side wall of the case to provide access to the computer for the electrical feed(s) through one of the openings 42 in tray wall 40. By spacing the rear tray wall 40 forwardly of the rear wall 20 of case 10, a storage area 47 is provided therebetween in which computer-related accessories and/or supplies can be stored. A pivotally or otherwise movably mounted cover 48 is provided for storage area 47 to secure the contents therein.

Through the aforesaid configuration, a lightweight, extremely durable and highly versatile case is provided for one's laptop computer. The case is preferably sized to accommodate the conventional laptop sizes such that in the closed position with the computer resting on or adjacent to support tray 13, the four sides of the computer are substantially adjacent the forward wall surface 34, rear tray wall 40 and the side walls 14 and 16 that project upwardly from tray 13. So positioned, the forward inclination of the support tray effects a pinching or clam shell securement of the computer between the tray 13 and the interior surface of the tambour roller door. While other door configurations could be employed, such as a flexible sheet of vinyl or other suitable material, the above-described tambour-type door construction provides additional protection for the contents of the case by providing cushioning space in the individual slats comprising the door and flexibility in the door itself. This flexibility results from the hinged slot construction previously described wherein any inward pressure on the door is partially absorbed by the flex in the slat and their individual hinge connections. This combination of the cushioning and flexibility in the door 22 provides enhanced protection for the goods within the case.

As a result of the above-described construction, the computer is securely held within the case and well protected by the interior wall and door surfaces therein and the tambour door 22. The outwardly projecting surfaces 14a and 16a on the side walls of the case formed by the molding of the interior door tracks 26 and 28, function as bumpers to enhance the protection of the computer. Similarly, the rear end of the computer is adjacent the rear tray wall 40 which is spaced inwardly from the rear wall 20 of the case 10 and the forward end of the computer is adjacent the rounded interior wall surface 34 extending upwardly from the forward end of the tray which, as seen in the drawings, is inwardly spaced from the forward outer surface of the case 10. Support tray 13 is also inwardly spaced from the bottom wall 12. The result is a well cushioned and very secure environment for the laptop computer during transportation.

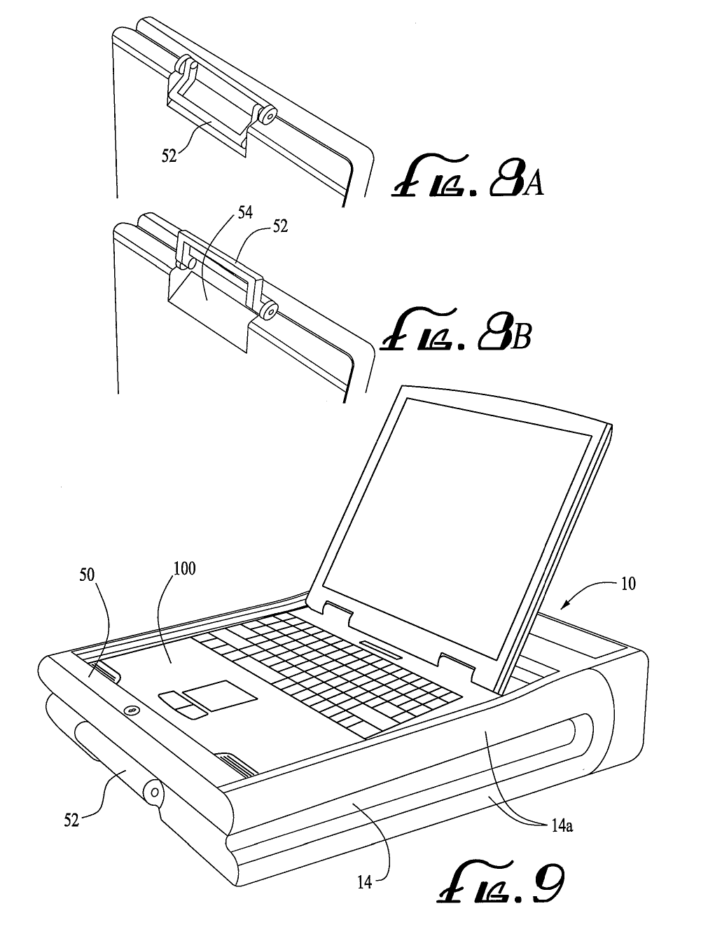

By spacing the bottom of the computer from the bottom wall 12 of the carrying case 10, the support tray 13 not only contributes to the isolation of the computer from the outer surfaces of the carrying case, it also cooperates with the bottom wall 12, as noted above, to define an area 32 for receiving the tambour door that is out of sight, does not interfere in any way with the access to or use of the computer, and avoids the need to store the case while the computer is in use. In addition, the area 32 with the door disposed therein during the use of the computer provides heat insulation between the computer and the bottom surface of the case to protect the user's lap while operating the computer for a prolonged period of time on his or her lap. The case 10 also provides a comfortable support surface 50 for the user's wrists and, by virtue of the inclination of tray 13, both raises the keyboard on the computer for easy access and allows for variations in the elevation of the keyboard. Support tray 13 can position the computer within the case such that when the case, with the computer therein, is placed on the floor or other horizontal surface in an upright position, as shown in FIG. 3, the center of gravity of the combined case and computer is positioned along the vertical center line of the computer to enhance the stability of the case in the upright position. A foldable handle 52 is preferably provided on the upper end of the case 10 to facilitate carrying of the case in the upright or brief case-like mode, while allowing the handle to be pivoted into a recess 54 formed in the upper end of the computer to facilitate storage as shown in FIGS. 8A and 8B. It is to be understood that the case 10 could be constructed of a variety of different materials, including aluminum, and be particularly configured to carry a variety of different items in a secure environment.

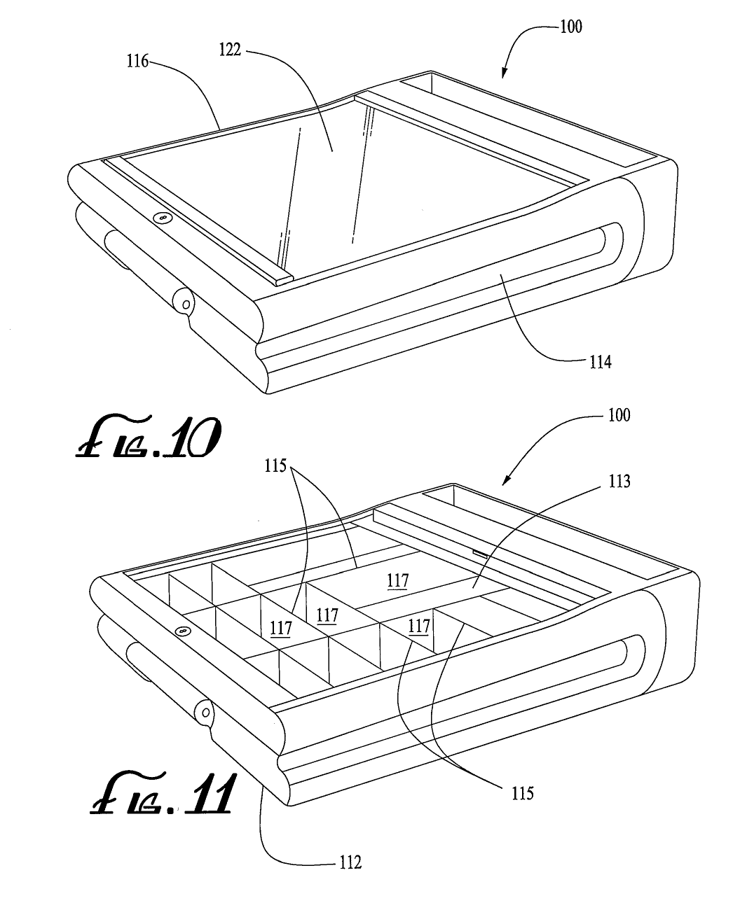

Another application for which the present invention is particularly well suited is for carrying fishing tackle. A second embodiment of the present invention tailored for such an application is illustrated in FIGS. 10 and 11. As seen therein, the carrying case 100 differs from case 10 in that the tambour door configuration of the prior embodiment has been replaced with a slidable door 122, preferably formed of a transparent and color tinted vinyl. The guide tracks in the side walls 114 and 116 of case 100 are sized and configured to accommodate the lateral end portions of the door 122 so as to provide the same sliding movement of the door between the closed and open positions described above with respect to door 22. The use of a sheet of vinyl material both allows the users to view the contents of the case while the door is in a closed position and assists in rendering the case 100 water resistant.

The support tray 113 in case 100 is provided with a plurality of upstanding wall sections 115 so as to provide a plurality of individual open-ended compartments 117 to segregate the various items of fishing tackle. The wall sections 115 preferably define an elevation slightly less than the distance between the support tray 113 and the sliding door 122 when the door is in the closed position. As a result, even the smaller fishing tackle items could be loosely stored in the various open-ended compartments 117 and held therein by the door when the carrying case 100 was disposed in the upright storage position illustrated in FIG. 10 as the door 122 effectively closes or seals the open ends of the individual compartments 117, securing the contents therein. Accordingly, case 100 substantially facilitates the location and access of the individual fishing tackle items when disposed in the horizontal position of FIG. 11, while defining a small footprint in its upright storage position (not shown). While the carrying case 100 is described and illustrated as having a transparent flexible door, solid doors, including tambour doors could also be employed. As with the first embodiment, the case 100 could be formed of ABS or, aluminum, or any other suitable rigid material. In addition, a filet cutting board (not shown), preferably formed of a suitable antibacterial plastic material, such as high density polyethylene, can be inset in the bottom wall 112 of the case 100. Also, the cutting board material can be impregnated with a germ fighting agent such as zinc oxide.

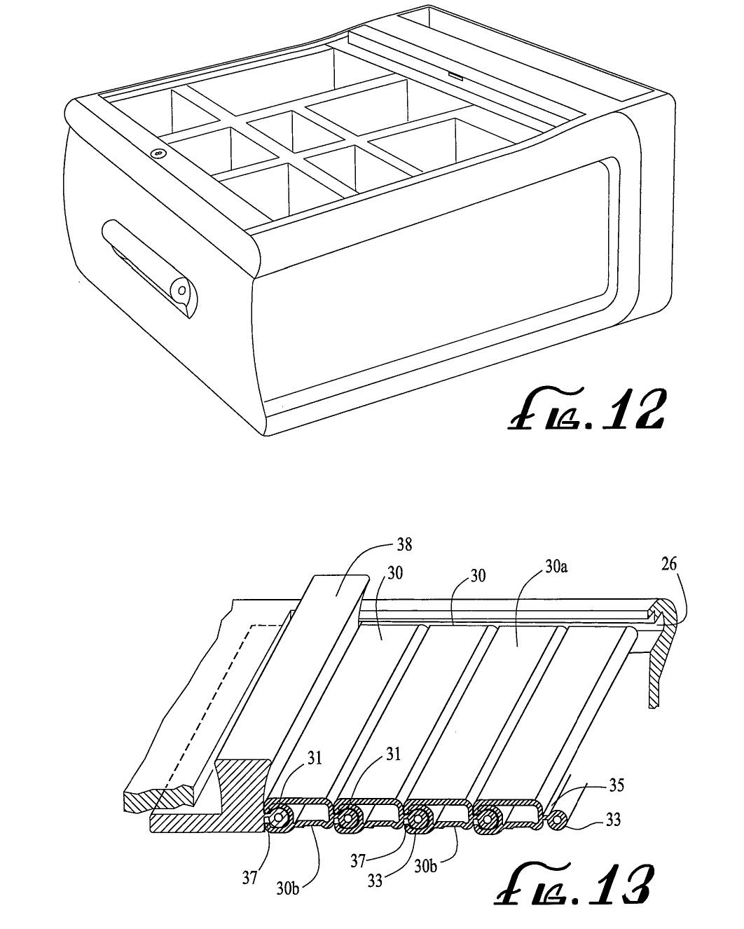

Yet another application for which the present invention is particularly well suited is that of a camera case (see FIG. 12). The small footprint defined by the case in the upright storage mode, the improved organization provided by the case for its contents and the enhanced protection afforded the contents of the case are features particularly well suited for carrying cameras with their assortment of lenses and various attachments. To effect the isolation of and further cushion the various individual camera components and attachments, a foam padding with cutout compartments therein is preferably disposed on the support tray.

It is to be understood that the carrying case of the present invention is not limited to the specific applications described herein. Also, various changes and modifications could be made in carrying out the present invention for the above-described and other applications. Insofar as such changes and modifications are within the purview of the appended claims, they are to be considered as part of the present invention.

I claim:

1. A case for a laptop computer, said case comprising: a bottom wall; a front wall; a rear wall; opposed sidewalls; an open upper end; an interior computer support spaced above said bottom wall so as to define a computer receiving area therebetween; and a door slidable between a closed position extending across said upper end of said case and an open position wherein said door is substantially disposed in said area between said bottom wall and said computer support so as to provide unobstructed access to the interior of said case through said upper end thereof.

2. The case of claim 1 wherein said door is a tambour door.

3. The case of claim 2 including a pair of opposed tracks on said side walls, said tambour door being carried by and slidable along said tracks between said closed and open positions.

4. The case of claim 2 wherein said bottom wall is planar and oriented for supporting said case in a stable, horizontal working mode and wherein said rear wall is planar and oriented for supporting said case in a stable, closed, upright carrying and storage mode.

5. The case of claim 3 wherein said tracks are of an elongated generally c-shaped configuration and are integrally formed in said side walls.

6. The case of claim 4 wherein said rear wall defines a first footprint equal in size to the area of said rear wall and said bottom wall defines a second footprint equal in size to the area of said bottom wall, said first footprint being substantially less than said second footprint whereby the available space required for the storage of said case is reduced.

7. The case of claim 5 wherein portions of said side walls adjacent said tracks project outwardly from said side walls and define gripping handles for moving said case in a horizontal disposition.

8. A case for supporting a laptop computer in a horizontal, open and unobstructed work mode and for securing a laptop computer therein in a closed, upright carrying and storage mode, said case comprising:
a bottom wall for supporting said case in the work mode; a front wall; a rear wall for supporting the case in the carrying and storage mode; opposite side walls; an open upper end; an interior computer support tray spaced above said bottom wall so as to define a thermal insulating cavity therebetween; and a door slidable between a closed position wherein said door extends across said upper end of said case and an open position wherein said door is substantially disposed in said cavity between said bottom wall and said support tray for using said case in said work mode.

9. The case of claim 8 wherein said door is a tambour door.

10. The case of claim 9 including a pair of opposed tracks on said side walls, said tambour door being carried by and slidable along said tracks between said closed and open positions.

11. The case of claim 9 wherein said tambour door is of a flexible and resilient construction and cooperates with said interior tray to define a shock resistant clam shell securement for a laptop computer upon a laptop computer being disposed on said interior tray and said door being slided over said upper end of said case to the closed position.

12. The case of claim 9 wherein said interior tray is positioned relative to said door and said bottom and rear walls such that upon disposing said case in said closed upright carrying and storage mode with a laptop computer disposed therein adjacent said tray, the center of gravity of the combined case and computer is positioned substantially equidistantly between said door and said bottom wall so as to maintain said case in a stable disposition on a horizontal surface.

13. The case of claim 9 including a rear interior computer support wall extending generally parallel to and spread forwardly of said rear wall of aid case so as to define a storage area therebetween, said rear interior wall being generally perpendicular to said interior computer support tray for supporting a laptop computer thereon in said carrying and storage mode.

14. The case of claim 10 wherein said tracks are of an elongated generally c-shaped configuration and are integrally formed in said side walls.

15. The case of claim 13 including at least one air vent in said rear interior computer support wall, said vent communicating with said thermal insulating cavity between said bottom wall of said case and said interior support tray.

16. The case of claim 14 wherein portions of said side walls adjacent said tracks project outwardly from said side walls and define gripping handles for moving said case in a horizontal disposition.

17. A case for carrying and storing a plurality of objects therein, said case comprising: a bottom wall; a front wall; a rear wall; opposed sidewalls; an open upper end; an interior support spaced above said bottom wall so as to define a cavity therebetween, said tray being partitioned to define a plurality of object storage areas thereon; and a door slidable between a closed position extending across said upper end of said case and an open position wherein said door is substantially disposed in said area between said bottom wall and said computer support so as to provide unobstructed access to the interior of said case through said upper end thereof.

18. The case of claim 17 wherein said door is a tambour door.

19. The case of claim 17 wherein said door is constructed of a flexible material.

20. The case of claim 17 wherein said door material is transparent.

21. The case of claim 17 including a pair of opposed tracks on said side walls, said door being carried by and slidable along said tracks between said closed and open positions.

22. The case of claim 17 wherein said bottom wall is planar and oriented for supporting said case in a stable, horizontal disposition and wherein said rear wall is planar and oriented for supporting said case in a stable, closed, upright carrying and storage disposition.

23. The case of claim 21 wherein said tracks are of an elongated generally c-shaped configuration and are integrally formed in said side walls.

24. The case of claim 22 wherein in said closed position, said door covers said storage areas so as to prevent any objects in one or more of said storage areas from falling therefrom upon said case being moved from a horizontal disposition to an upright carrying and storage disposition.

25. The case of claim 24 wherein said door is a tambour door.

26. The case of claim 24 wherein said door is constructed of a flexible material.

27. A case for carrying and storing fishing tackle therein, said case comprising: a bottom wall; a front wall; a rear wall; opposed side walls; an open upper end; an interior support tray spaced above said bottom wall so as to define a cavity therebetween, said tray defining a plurality of tackle storage areas thereon; and a door slidable between a closed position and an open position, in said closed position, said door extending across said upper end of said case and covering said tackle storage area so as to prevent any tackle therein from falling therefrom upon said case being moved from a horizontal disposition to an upright disposition and in said open position, said door is substantially disposed in said cavity between said bottom wall and said support tray so as to provide unobstructed access to said tackle storage areas through said upper end of said case.

28. The case of claim 27 wherein said door is a tambour door.

29. The case of claim 27 wherein said door is constructed of a flexible transparent material.

30. The case of claim 27 including a pair of opposed tracks on said side walls, said door being carried by and slidable along said tracks between said closed and open positions.
